(19) United States
(12) Patent Application Publication
(10) Pub. No.: US 2024/0334795 A1
(43) Pub. Date: Oct. 3, 2024

(54) DISPLAY PANEL AND DISPLAY DEVICE

(71) Applicant: HKC Corporation Limited, Shenzhen (CN)

(72) Inventors: Jing LI, Shenzhen (CN); Ting Zhou, Shenzhen (CN); Tianjun Huang, Shenzhen (CN); Baohong Kang, Shenzhen (CN)

(21) Appl. No.: 18/470,532

(22) Filed: Sep. 20, 2023

(30) Foreign Application Priority Data
Mar. 30, 2023 (CN) 202310328574.0

(51) Int. Cl. H10K 59/80; G06V 40/13; H10K 59/122; H10K 59/35; H10K 59/60

(52) U.S. Cl. CPC H10K 59/8792; G06V 40/1318; H10K 59/122; H10K 59/353; H10K 59/60; H10K 59/80518; H10K 59/873

(57) ABSTRACT

A display panel includes a substrate, a driving circuit layer, a light emitting layer and a light shielding layer. The driving circuit layer includes photosensitive devices. The light emitting layer includes a plurality of anti-peeping sub-pixels and a plurality of display sub-pixels. The light shielding layer includes a plurality of light shielding components. Each of the light shielding components includes a light transmitting area and a light shielding area located on at least one side of the light transmitting area. A corresponding one of the photosensitive devices can receive at least part of light reflected by a fingerprint through the light transmitting area. An orthographic projection of each of the anti-peeping sub-pixels on the light shielding layer is at least partially located in a corresponding one of the light shielding components.

### CROSS-REFERENCE TO RELATED APPLICATIONS

This application claims priority to Chinese Patent Application No. 202310328574.0, filed Mar. 30, 2023, the entire disclosure of which is incorporated herein by reference.

### TECHNICAL FIELD

The present application relates to the technical field of displaying, and more specifically, to a display panel and a display device.

### BACKGROUND

OLED (Organic Light-Emitting Diode) display panels do not require backlight, and have the advantages of bendability, small thickness, high brightness, low power consumption, fast response, wide color gamut and the like, thereby being widely used in devices such as mobile phones and laptops.

Everyone has a unique fingerprint. Fingerprint recognition modules are added for the display panels to unlock the devices such as the mobile phones and the laptops, which can effectively protect trade secrets and personal privacy. Generally, a fingerprint recognition module is arranged under the screen. During fingerprint recognition, light emitted by an organic light-emitting diode on the fingerprint recognition module needs to be reflected by a finger and received by the fingerprint recognition module. Due to the fixed position of the fingerprint recognition module under the screen, the fingerprint recognition module needs to be accurately pressed with the finger for fingerprint recognition during unlocking, resulting in slow and inconvenient unlocking of the device. In addition, the frequent turn-on of the organic light-emitting diode on the fingerprint recognition module during fingerprint recognition increases the risk of image retention due to screen burn-in of the display panel.

### SUMMARY

There are provided a display panel and a display device. The technical solution is as below:

According to a first aspect of the present disclosure, there is provided a display panel, including a substrate;
a driving circuit layer formed on a side of the substrate, the driving circuit layer includes photosensitive devices;
a light emitting layer formed on a side of the driving circuit layer away from the substrate, the light emitting layer includes a plurality of anti-peeping sub-pixels and a plurality of display sub-pixels; and
a light shielding layer including a plurality of light shielding components. Each of the light shielding components includes a light transmitting area and a light shielding area located on at least one side of the light transmitting area, a corresponding one of the photosensitive devices is capable of receiving at least part of light reflected by a fingerprint through the light transmitting area, and an orthographic projection of each of the anti-peeping sub-pixels on the light shielding layer is at least partially located in a corresponding one of the light shielding components.

According to a second aspect of the present disclosure, there is provided a display device, including the display panel above and a mainboard, and the mainboard is connected to the display panel.

It should be understood that the general description above and the detailed description below are only exemplary and explanatory, and cannot limit the present disclosure.

### BRIEF DESCRIPTION OF THE DRAWINGS

The accompanying drawings herein are incorporated into the specification to constitute a part of this specification, show the embodiments in accordance with the present application, and are used together with the specification to explain the principle of the present application. Apparently, the accompanying drawings in the description below merely illustrate some embodiments of the present application. Those of ordinary skill in the art may also derive other accompanying drawings from these accompanying drawings without creative efforts.

FIG. 1 is a schematic structural diagram of a display panel in Embodiment 1 of the present application.

FIG. 2 is a schematic structural diagram of a pixel unit in Embodiment 1 of the present application.

FIG. 3 is a schematic diagram of an anti-peeping principle of the display panel in FIG. 1.

FIG. 4 is a schematic structural diagram of a display panel in Embodiment 2 of the present application.

FIG. 5 is a schematic structural diagram of a display panel in Embodiment 3 of the present application.

FIG. 6 is a schematic structural diagram of a pixel unit in Embodiment 3 of the present application.

FIG. 7 is a structural schematic diagram of a display panel in Embodiment 4 of the present application.

FIG. 8 is a schematic structural diagram of a pixel unit in Embodiment 4 of the present application.

FIG. 9 is a schematic structural diagram of a display device in Embodiment 5 of the present application.

FIG. 10 is a schematic diagram showing arrangement of first pixel rows and second pixel rows of the present application.

### DETAILED DESCRIPTION OF THE EMBODIMENTS

The exemplary embodiments will now be described more fully with reference to the accompanying drawings. However, the exemplary embodiments can be implemented in various forms and should not be understood to be limited to the examples elaborated herein; and rather, these embodiments are provided so that the present application will be more comprehensive and complete, and the concept of the exemplary embodiments will be fully communicated to those skilled in the art.

In addition, the features, structures, or characteristics described may be combined in any suitable way in one or more embodiments. In the description below, many specific details are provided to give a full understanding of the embodiments of the present application. However, those skilled in the art will realize that the technical solution of the present application may be practiced without one or more specific details, or other methods, components, devices, steps, etc. may be employed. In other cases, the well-known methods, devices, implementations, or operations are not shown or described in detail to avoid blurring various aspects of the present application.

The present application is further described in detail below in conjunction with the accompanying drawings and the specific embodiments. Herein, it should be noted that the technical features involved in the embodiments of the present application described below may be combined with each other as long as they do not conflict with each other. The embodiments described below with reference to the accompanying drawings are exemplary, are intended to explain the present application, and should not be construed as a limitation to the present application.

### Embodiment 1

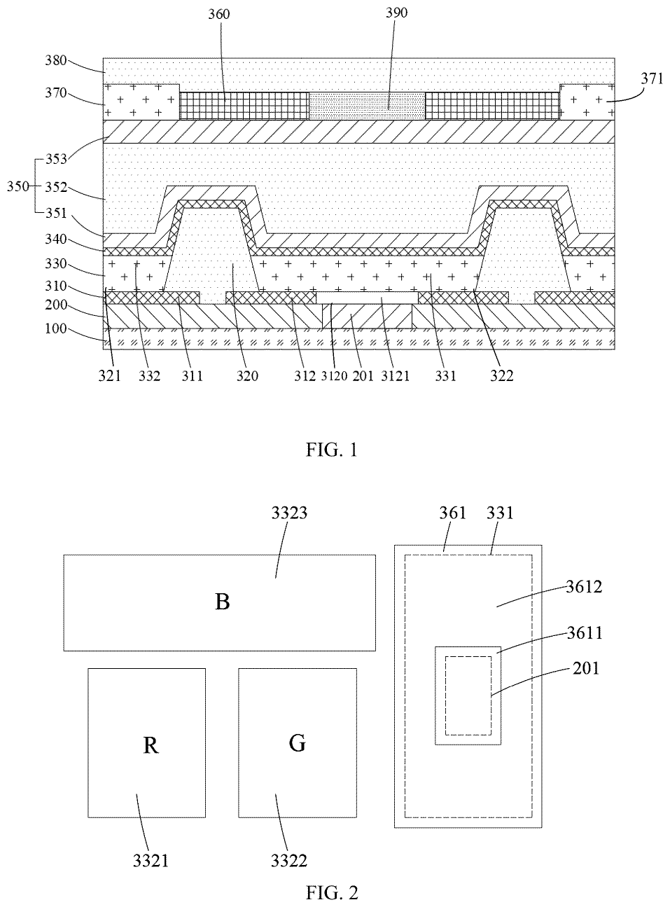

As shown in FIG. 1, a display panel in this embodiment includes a substrate 100, a driving circuit layer 200, a light emitting layer 330, and a light shielding layer 360.

The driving circuit layer 200 is formed on a side of the substrate 100. The substrate 100 may include a glass substrate and a polyimide (Pi) substrate. The driving circuit layer 200 may include driving transistors and photosensitive devices 201 for fingerprint identification. Each photosensitive device 201 may include an amorphous silicon (a-Si) transistor, a low-temperature polycrystalline silicon (LTPS) transistor, and an indium gallium zinc oxide (IGZO) transistor.

The light emitting layer 330 is formed on a side of the driving circuit layer 200 away from the substrate 100, and includes a plurality of pixel units. Each pixel unit includes a plurality of display sub-pixels 332 and at least one anti-peeping sub-pixel 331. The plurality of display sub-pixels 332 may include a red display sub-pixel 3321 (R), a green display sub-pixel 3322 (G), and a blue display sub-pixel 3323 (B).

The light shielding layer 360 includes a plurality of light shielding components 361. The light shielding components 361, the pixel units, and the photosensitive devices 201 may be arranged in a one-to-one correspondence manner. Each light shielding component 361 includes a light transmitting area 3611 and a light shielding area 3612 located on at least one side of the light transmitting area 3611. For example, when one light shielding area 3612 is arranged, the light shielding area 3612 is located on an upper side, a lower side, a left side, or a right side of the light transmitting area 3611; when two light shielding areas 3612 are arranged, the two light shielding areas 3612 are located on any two sides of the upper side, the lower side, the left side, and the right side of the light transmitting area 3611; and when four light shielding areas 3612 are arranged, the four light shielding areas 3612 are located on the upper side, the lower side, the left side, and the right side of the light transmitting area 3611, respectively, to surround the light transmitting area 3611. An orthographic projection of each anti-peeping sub-pixel 331 on the light shielding layer 360 is located in the corresponding light shielding component 361.

During fingerprint recognition, the anti-peeping sub-pixels 331 emit light to illuminate a fingerprint, and part of light from the display sub-pixels 332 also illuminates the 20) fingerprint; light reflected by the fingerprint can illuminate the corresponding photosensitive device 201 through the light transmitting area 3611; and the corresponding photosensitive device 201 can receive at least part of the light reflected by the fingerprint through the light transmitting area 3611, so as to recognize the fingerprint.

The display panel has an anti-peeping mode. When the anti-peeping mode is disabled, the display sub-pixels 332 perform normal display, and the anti-peeping sub-pixels 331 are turned off, so that the display panel can perform clear display during direct viewing or squinting. When the anti-peeping mode is enabled, the anti-peeping sub-pixels 331 are turned on, light emitted forwards by the anti-peeping sub-pixels 331 is shielded by the light shielding components 361, and light emitted forwards by the display sub-pixels 332 is not disturbed, so that the display panel can perform clear display during direct viewing; and light emitted obliquely by the anti-peeping sub-pixels 331 is not shielded by the light shielding components 361, and light emitted obliquely by the display sub-pixels 332 will be mixed with the light emitted obliquely by the anti-peeping sub-pixels 331, so that the display panel cannot perform clear display during squinting, thus achieving the anti-peeping effect.

As shown in FIG. 3, a structure such as cover plate glass or a polarizer is further generally arranged on a side of the light shielding layer 360 away from the substrate 100. Light, passing around the light shielding components 361, of the anti-peeping sub-pixels 331 is anti-peeping light, and the anti-peeping light emitted from edge areas of each anti-peeping sub-pixel 331 can pass through the structure such as the cover plate glass or the polarizer; and due to a larger light emitting angle than the edge areas, the anti-peeping light emitted from a central area of each anti-peeping sub-pixel 331 will be totally reflected on the cover plate glass or the polarizer, which not only fails to achieve the anti-peeping effect, but may also interfere with light emitted by the corresponding display sub-pixel 332. Based on this, in some technical solutions, each light shielding component 361 of the display panel includes the light transmitting area 3611 and the light shielding area 3612 located on at least one side of the light transmitting area 3611, and specifically may be designed to be in a dual-square or concentric-square shape, and the corresponding anti-peeping sub-pixels 331 may also be designed to be in a similar shape, which not only saves materials for manufacturing the light shielding components 361 and the anti-peeping sub-pixels 331, but also improves the light output of the anti-peeping sub-pixels 331, thereby improving the light utilization rate.

In this embodiment, the driving circuit layer 200 is formed on a side of the substrate 100 and includes the photosensitive devices 201. The light emitting layer 330 is formed on a side of the driving circuit layer 200 away from the substrate 100, and includes a plurality of display sub-pixels 332 and a plurality of anti-peeping sub-pixels 331. The light shielding layer 360 includes a plurality of light shielding components 361, each of the light shielding component 361 includes the light transmitting area 3611 and the light shielding area 3612 located on at least one side of the light transmitting area 3611, the orthographic projection of each anti-peeping sub-pixel 331 on the light shielding layer 360 is located in the corresponding light shielding component 361, and the corresponding photosensitive device 201 can receive at least part of the light reflected by the fingerprint through the light transmitting area 3611 to recognize the fingerprint; and the light transmitting area 3611 is used as an optical channel for fingerprint recognition, which can reduce the occupation of a design space for the display panel by a fingerprint recognition structure and achieve the full screen fingerprint recognition, thereby improving the speed and convenience of fingerprint recognition.

For example, as shown in FIG. 1 and FIG. 2, an orthographic projection of the corresponding photosensitive device 201 on the light shielding layer 360 at least partially overlaps with the light transmitting area 3611. Specifically, the light shielding layer 360 may be made from a black light shielding material, and the light transmitting area 3611 may be of a hole or groove structure formed by hollowing out the corresponding light shielding component 361. The light transmitting area 3611 may be equal to or slightly larger than the corresponding photosensitive device 201 in size, so that the orthographic projection of the corresponding photosensitive device 201 on the light shielding layer 360 can be located in or coincides with the light transmitting area 3611.

The orthographic projection of the corresponding photosensitive device 201 on the light shielding layer 360 at least partially overlaps with the light transmitting area 3611. In such design, it can be ensured that the corresponding photosensitive device 201 receives sufficient light reflected by the fingerprint through the light transmitting area 3611, thereby improving the accuracy and speed of fingerprint recognition.

As shown in FIG. 1 and FIG. 2, each light shielding component 361 includes two light shielding areas 3612 located on two sides of the light transmitting area 3611 in a row direction, respectively.

For a product such as a display and a laptop, it is difficult to peep from an up-down direction and usually only needs to have the better anti-peeping effect in a left-right direction. In this embodiment, the two light shielding areas 3612 are located on the two sides of the light transmitting area 3611 in the row direction, respectively. Such design allows the display panel to have the better anti-peeping effect in the left-right direction, and can reduce the consumption of an organic light-emitting material for making the anti-peeping sub-pixels 331 and the manufacturing cost of the display panel.

In some embodiments, each light shielding component 361 includes four light shielding areas 3612. Two of the light shielding areas 3612 are located on the two sides of the light transmitting area 3611 in the row direction, respectively, and another two of the light shielding areas 3612 are located on two sides of the light transmitting area 3611 in a column direction, respectively. In other words, the light shielding components 361 may be designed to be of a concentric-square-shaped structure.

For a product such as a mobile phone and a tablet computer, it needs to have the better anti-peeping effect in the up-down direction, to prevent peeping in all directions. In the embodiments, each light shielding component 361 includes the four light shielding areas 3612. Two of the light shielding areas 3612 are located on the two sides of the light transmitting area 3611 in the row direction, respectively, and another two of the light shielding areas 3612 are located on the two sides of the light transmitting area 3611 in the column direction, respectively. In such design, the display panel has the better anti-peeping effect in the up-down direction.

As shown in FIG. 1 and FIG. 2, the display panel further includes a piezoelectric film 390. The piezoelectric film 390 includes a plurality of piezoelectric components 391, and a projection of the light transmitting area 3611 on the piezoelectric film 390 is located in or coincides with the corresponding piezoelectric component 391. The piezoelectric film 390 has a transparent state and an opaque state. The piezoelectric film 390 is in the transparent state when being pressed, and the piezoelectric film 390 is in the opaque state when being in a natural state. That is, the piezoelectric film 390 is transparent when it is pressed and is opaque in its natural state.

During fingerprint recognition, the piezoelectric film 390 is in the transparent state when it is pressed by the user's finger, and both the light for illuminating the fingerprint and the light reflected by the fingerprint can pass through the light transmitting area 3611 and the piezoelectric film 390; and after the fingerprint recognition, the piezoelectric film 390 is in the opaque state when in its natural state, the light for illuminating the light transmitting area 3611, from the corresponding anti-peeping sub-pixel 331, will be shielded by the piezoelectric film 390 in the opaque state, thereby preventing the light in the middle of the corresponding anti-peeping sub-pixel 331 from passing through the light transmitting area 3611 to affect the display of the corresponding display sub-pixel 332.

It should be noted that the display panel may be provided with the piezoelectric film 390 to shield the light, thereby preventing the light in the middle of the corresponding anti-peeping sub-pixel 331 from passing through the light transmitting area 3611 to affect the display of the corresponding display sub-pixel 332. However, the display panel is not limited thereto. Due to a smaller size of the light transmitting area 3611 of each light shielding component 361, a small amount of light passing through the light transmitting area 3611 will not significantly affect the display of the corresponding display sub-pixel 332 and will only be affected in the anti-peeping mode, so that the piezoelectric film 390 may also be removed, depending on the specific situation.

As shown in FIG. 1 and FIG. 2, each light shielding component 361 is hollowed out to form the light transmitting area 3611, and each piezoelectric component 391 is located in the light transmitting area 3611. When each piezoelectric component 391 is located in the light transmitting area 3611, the projection of the light transmitting area 3611 on the piezoelectric film 390 is located in or coincides with the corresponding piezoelectric component 391.

It should be noted that each piezoelectric component 391 may be arranged in the light transmitting area 3611, but is not limited thereto. Each piezoelectric component 391 may also be arranged on one side of the corresponding light shielding component 361, depending on the specific situation. For example, each piezoelectric component 391 is arranged on a side of the corresponding light shielding component 361 away from the substrate 100. When each piezoelectric component 391 is arranged on a side of the corresponding light shielding component 361, the projection of the light transmitting area 3611 on the piezoelectric film 390 is located in the corresponding piezoelectric component 391, thereby preventing the corresponding piezoelectric component 391 from falling into the light transmitting area 3611.

As shown in FIG. 1 and FIG. 2, the display panel further includes a first anode layer 310, a pixel definition layer 320, and a cathode layer 340. The driving circuit layer 200, the first anode layer 310, the pixel definition layer 320, the light emitting layer 330, the cathode layer 340, and the light shielding layer 360 are sequentially formed.

The first anode layer 310 includes a plurality of first anodes 311 and a plurality of second anodes 312. The pixel definition layer 320 includes a plurality of first via holes 321 and a plurality of second via holes 322. The display sub-pixels 332 are at least partially located in the first via holes 321 and are connected to the first anodes 311 in a one-to-one correspondence manner. The anti-peeping sub-pixels 331 are at least partially located in the second via holes 322 and are connected to the second anodes 312 in a one-to-one correspondence manner.

Each of the first anodes 311 and the second anodes 312 includes an ITO (Indium Tin Oxide) layer and a reflective layer 3120. The reflective layer 3120 may be a silver metal layer or the like. At least the reflective layer 3120 includes a second hollow area 3121. An orthographic projection of the corresponding photosensitive device 201 on the first anode layer 310 is located in the second hollow area 3121.

Each of the first anodes 311 and the second anodes 312 includes the ITO layer and the reflective layer 3120. The reflective layer 3120 can reflect light emitted downwards by the corresponding anti-peeping sub-pixel 331 and display sub-pixel 332, thereby improving the light utilization rate.

As shown in FIG. 1 and FIG. 2, the driving circuit layer 200 further includes the driving transistors. Each display sub-pixel 332 and each anti-peeping sub-pixel 331 are correspondingly connected to one driving transistor.

The display panel usually requires fingerprint recognition in a display mode. After the fingerprint recognition is unlocked, when the protection of the trade secrets or the personal privacy is required, the anti-peeping sub-pixels 331 are turned on, and the display panel is switched to the anti-peeping mode. Turning on the anti-peeping sub-pixels 331 in the display mode may affect normal display of the display panel.

In this embodiment, the driving circuit layer 200 further includes the driving transistors. Each display sub-pixel 332 and each anti-peeping sub-pixel 331 are correspondingly connected to one driving transistor. When the anti-peeping sub-pixels 331 are turned on for fingerprint recognition in the display mode, only the anti-peeping sub-pixels 331 in the area pressed by the user's finger can be turned on, thereby preventing the anti-peeping sub-pixels 331 in other areas from being turned on to affect normal display of the display panel. In addition, since each display sub-pixel 332 and each anti-peeping sub-pixel 331 are correspondingly connected to one driving transistor, the display panel may also be designed in an anti-peeping area division manner. That is, the anti-peeping mode is enabled for some areas of the display panel and is disabled for some other areas of the display panel.

As shown in FIG. 1 and FIG. 2, the display panel further includes an encapsulating layer 350. The encapsulating layer 350 is formed on a side of the cathode layer 340 away from the substrate 100, and the light shielding layer 360 is formed on a side of the encapsulating layer 350 away from the substrate 100. The encapsulating layer 350 includes a first inorganic encapsulating layer 351, an organic encapsulating layer 352, and a second inorganic encapsulating layer 353. The first inorganic encapsulating layer 351 is formed on a side of the cathode layer 340 away from the substrate 100, the organic encapsulating layer 352 is formed on a side of the first inorganic encapsulating layer 351 away from the substrate 100, and the second inorganic encapsulating layer 353 is formed on a side of the organic encapsulating layer 352 away from the substrate 100.

The encapsulating layer 350 is formed between the cathode layer 340 and the light shielding layer 360, which can prevent the failure of the light emitting layer 330 formed by the organic light-emitting material from being invaded by water and oxygen. The light shielding layer 360 is formed on a side of the encapsulating layer 350 away from the substrate 100, which can increase the distance between the light shielding layer 360 and the light emitting layer 330, thereby facilitating the adjustment of the light emitting angle of the anti-peeping sub-pixels 331.

As shown in FIG. 1 and FIG. 2, the display panel may further include a color resistor layer 370 and an anti-reflective layer 380. The color resistor layer 370 is formed on a side of the encapsulating layer 350 away from the substrate 100, the color resistor layer 370 includes a plurality of color resistors 371, and orthographic projections of the display sub-pixels 332 on the color resistor layer 370 are located in the color resistors 371 in a one-to-one correspondence manner. The plurality of color resistors 371 are a red resistor, a green resistor, and a blue resistor, respectively. The red resistor, the green resistor, and the blue color resistor are in a one-to-one correspondence with the red display sub-pixel 3321, the green display sub-pixel 3322, and the blue display sub-pixel 3323. The light shielding layer 360 further includes black matrixes arranged on the same layer as the light shielding components 361. The black matrixes are arranged around the red resistor, the green resistor, and the blue resistor. Light emitting gaps are provided between the peripheries of the light shielding components 361 and the black matrixes and between the peripheries of the light shielding components 361 and the color resistors, to facilitate the anti-peeping sub-pixels 331 to emit the light from the peripheries of the light shielding components 361. The anti-reflective layer 380 is formed on a side of the color resistor layer 370 away from the substrate 100.

To improve the contrast of a display device and achieve the integrated black effect, the polarizer is usually used for the OLED display panel, because the polarizer can effectively reduce the reflection intensity of external ambient light on a screen. However, the light transmittance of the polarizer is generally only about 44%, so that higher power needs to be provided for achieving higher light emitting brightness. In addition, the polarizer is thicker and brittle, which is unfavourable for the development of a dynamic bending product.

In this embodiment, the display panel includes the anti-reflective layer 380, which can reduce the reflection intensity of the external ambient light on the screen. In addition, the anti-reflective layer 380 further has a certain blocking effect, which can protect the OLED display panel. The anti-reflective layer 380 is used to reduce the reflection intensity of the external ambient light on the screen, the color resistor layer 370 is used to block the external light and filter light emitted by display light emitting units, and the polarizer of the OLED display panel can be removed, so that the thickness of a function layer will be greatly reduced, and the light emitting rate can be increased from 44% to 80%, thereby greatly increasing the light emitting brightness, and reducing the power consumption of the OLED display panel.

### Embodiment 2

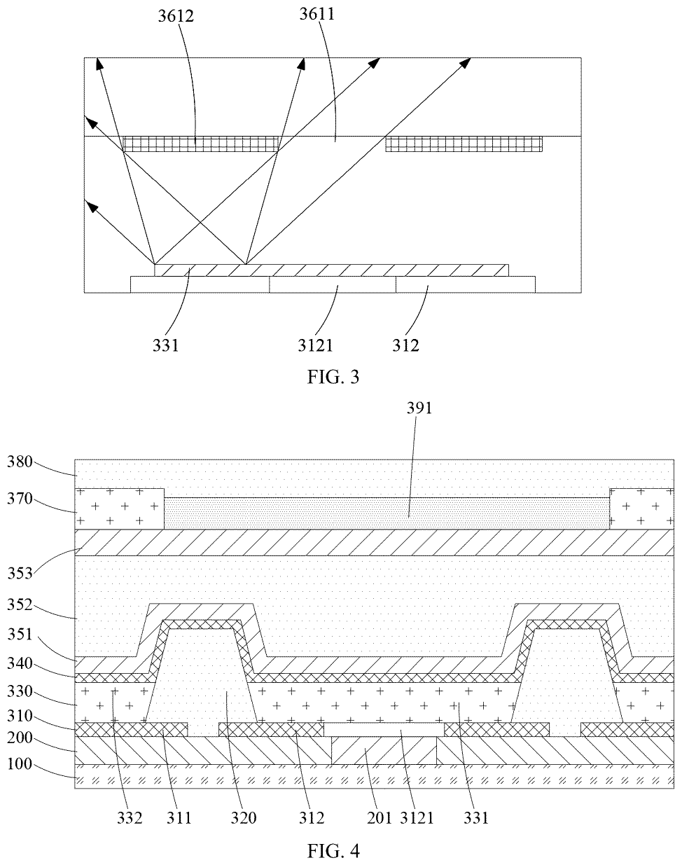

As shown in FIG. 4, the main difference between Embodiment 2 and Embodiment 1 is that the light shielding layer 360 is different.

In Embodiment 1, the display panel includes the light shielding layer 360 and the piezoelectric film 390. The light shielding layer 360 is made from a black light shielding material. The light shielding layer 360 includes a plurality of light shielding components 361. Each light shielding component 361 is hollowed out to form the light transmitting area 3611. The piezoelectric film 390 includes the piezoelectric components 391. Each piezoelectric component 391 is located in the light transmitting area 3611 or located on a side of the corresponding light shielding component 361.

In this embodiment, the light shielding layer 360 is the piezoelectric film 390 and is made from a piezoelectric material, and the light shielding layer 360 includes a transparent state and an opaque state. The light shielding layer 360 is transparent when it is pressed and is opaque in its natural state. The light shielding layer 360 includes a plurality of light shielding components 361. The light transmitting area 3611 of each light shielding component 361 is an area where the orthographic projection of the corresponding photosensitive device 201 on the light shielding layer 360 is located, and the light shielding area 3612 is an area outside the light transmitting area 3611.

The light shielding layer 360 is the piezoelectric film 390, and the light shielding layer 360 is transparent when it is pressed and is opaque in its natural state, which can simplify the structure of the display panel and reduce the manufacturing cost of the display panel compared with Embodiment 1.

### Embodiment 3

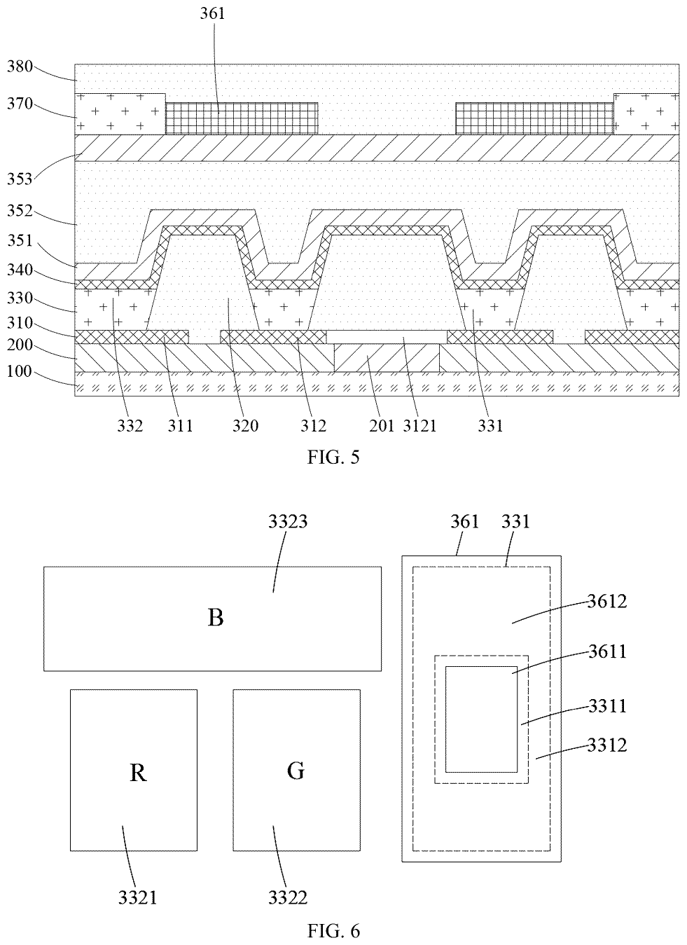

As shown in FIG. 5 and FIG. 6, the main difference between Embodiment 3 and Embodiment 1 is that the structure of the anti-peeping sub-pixels 331 is different.

In Embodiment 1, the light shielding layer 360 includes a plurality of light shielding components 361. Each light shielding component 361 is hollowed out to form the light transmitting area 3611. The piezoelectric film 390 includes the piezoelectric components 391. Each piezoelectric component 391 is located in the light transmitting area 3611 or on a side of the corresponding light shielding component 361. The piezoelectric film 390 can shield the light in the middles of the anti-peeping sub-pixels 331, thereby preventing the light in the middle of the corresponding anti-peeping sub-pixel 331 from passing through the light transmitting area 3611 to affect the display of the panel display.

In this embodiment, when the light shielding components 361 are designed to be of the concentric-square-shaped structure, the middles of the anti-peeping sub-pixels 331 may also be designed to be hollow. Each of the anti-peeping sub-pixels 331 includes a first hollow area 3311 and edge areas 3312. The edge areas 3312 are arranged around the first hollow area 3311, an orthographic projection of the first hollow area 3311 on the light shielding layer 360 is located in the light transmitting area 3611, and an orthographic projection of each edge area 3312 on the light shielding layer 360 is located in the corresponding light shielding area 3612. In other words, when the light shielding components 361 are designed to be of the concentric-square-shaped structure, the anti-peeping sub-pixels 331 may also be designed to be of a similar concentric-square-shaped structure.

When the light shielding components 361 are designed to be of the concentric-square-shaped structure, the anti-peeping sub-pixels 331 are also designed to be of the similar concentric-square-shaped structure. In such design, the light in the middle of the corresponding anti-peeping sub-pixel 331 can be prevented from being emitted through the light transmitting area 3611 to affect the display of the corresponding display sub-pixel 332.

There is a main difference between Embodiment 4 and Embodiment 1 that the first anode layer 310 is different in structure.

### Embodiment 4

the main difference between Embodiment 4 and Embodiment 1 is that the structure of the first anode layer 310 is different.

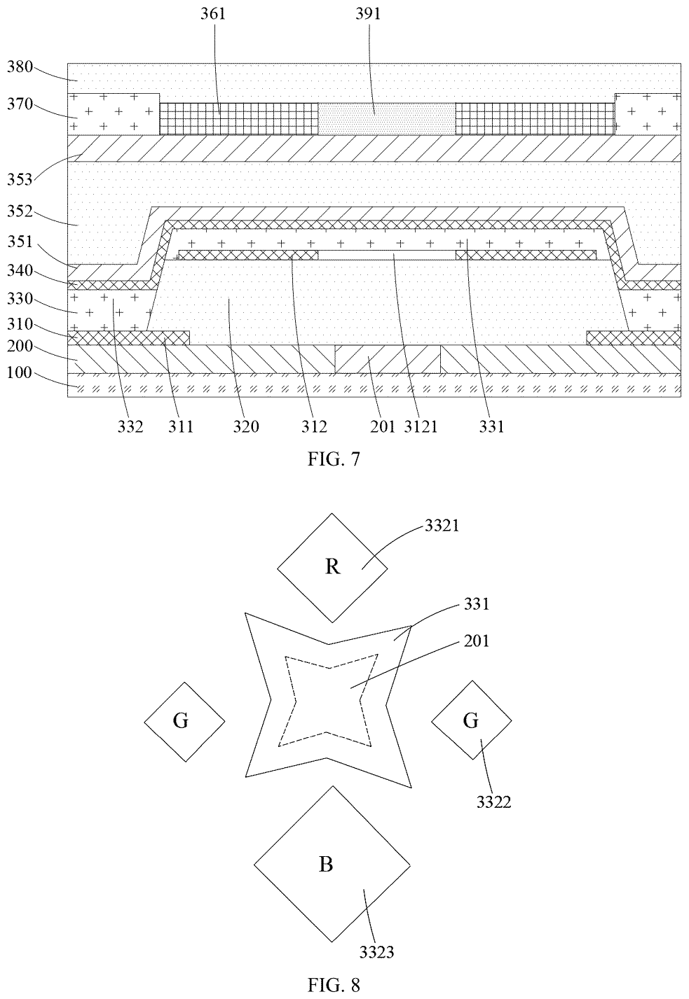

As shown in FIG. 7 and FIG. 8, the display panel further includes the first anode layer 310, the pixel definition layer 320, a second anode layer, and the cathode layer 340. The driving circuit layer 200, the first anode layer 310, the pixel definition layer 320, the second anode layer, the light emitting layer 330, the cathode layer 340, and the light shielding layer 360 are sequentially formed.

The first anode layer 310 includes a plurality of first anodes 311, and the second anode layer includes a plurality of second anodes 312. The pixel definition layer 320 includes the first via holes, and the display sub-pixels 332 are at least partially located in the first via holes and are connected to the first anodes 311 in a one-to-one correspondence manner. Each anti-peeping sub-pixel 331 is located between the two adjacent first via holes, and each second anode 312 is located between the two adjacent first via holes.

Each of the second anodes 312 includes the ITO layer and the reflective layer. The reflective layer may be the silver metal layer or the like. At least the reflective layer includes the second hollow area 3121, and the orthographic projection of the corresponding photosensitive device 201 on the second anode layer is located in the second hollow area 3121.

Each of the second anodes 312 includes the ITO layer and the reflective layer. The reflective layer can reflect light emitted downwards by the corresponding anti-peeping sub-pixel 331, thereby improving the light utilization rate.

As shown in FIG. 7, FIG. 8 and FIG. 10, the plurality of display sub-pixels 332 include a red display sub-pixel 3321, green display sub-pixels 3322, and a blue display sub-pixel 3323. The plurality of display sub-pixels 332 are distributed in a plurality of first pixel rows and a plurality of second pixel rows. The first pixel rows and the second pixel rows are arranged alternately in the column direction. The red display sub-pixel 3321 and the blue display sub-pixel 3323 are arranged at intervals and alternately in the first pixel rows, while the red display sub-pixel 3321 and the blue display sub-pixel 3323 are arranged at intervals and alternately in the column direction. The green display sub-pixels 3322 are arranged at intervals in the second pixel rows, and the green display sub-pixels 3322 are staggered from both the red display sub-pixel 3321 and the blue display sub-pixel 3323 in the column direction, that is, the green display sub-pixels 3322 and the red display sub-pixel 3321 are not located in a same column, and the green display sub-pixels 3322 and the blue display sub-pixel 3323 are also not located in a same column. In other words, the red display sub-pixel 3321, the green display sub-pixels 3322, and the blue display sub-pixel 3323 are arranged according to a diamond-like arrangement. Each anti-peeping sub-pixel 331 is arranged between the two adjacent green display sub-pixels 3322 and between the red display sub-pixel 3321 and the blue display sub-pixel 3323 that are adjacent to each other.

The area of the red display sub-pixel 3321 is smaller than the area of the blue display sub-pixel 3323 and is larger than the area of each green display sub-pixel 3322. In other words, the single green display sub-pixel 3322 has a minimum area, while the single blue display sub-pixel 3323 has a maximum area. The red display sub-pixel 3321, the green display sub-pixels 3322, and the blue display sub-pixel 3323 are all formed from the organic light-emitting material. The organic light-emitting material for forming the blue display sub-pixel 3323 has lower efficiency, while the organic light-emitting material for forming the green display sub-pixels 3322 has higher efficiency. The area of the red display sub-pixel 3321 is set to be smaller than the area of the blue display sub-pixel 3323 and larger than the area of each green display sub-pixel 3322, which can balance the brightness and life of the red display sub-pixel 3321, the green display sub-pixels 3322, and the blue display sub-pixel 3323.

### Embodiment 5

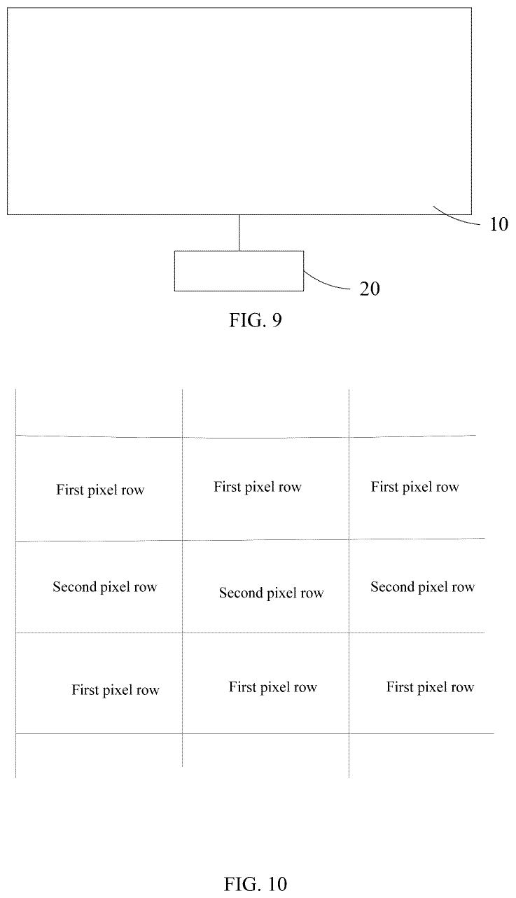

As shown in FIG. 9, a display device includes a display panel 10 and a mainboard 20. The mainboard 20 is connected to the display panel 10 and configured to drive the display panel 10 to display images. The display panel 10 includes the display panel 10 disclosed in Embodiment 1 to Embodiment 4.

The display device includes the display panel 10. In the display panel 10, a driving circuit layer 200 is formed on a side of a substrate 100 and includes photosensitive devices 201; a light emitting layer 330 is formed on a side of the driving circuit layer 200 away from the substrate 100, and includes a plurality of display sub-pixels 332 and a plurality of anti-peeping sub-pixels 331; and a light shielding layer 360 includes a plurality of light shielding components 361, each light shielding component 361 includes a light transmitting area 3611 and a light shielding area 3612 located on at least one side of the light transmitting area 3611, an orthographic projection of each anti-peeping sub-pixel 331 on the light shielding layer 360 is located in the corresponding light shielding component 361, and the corresponding photosensitive device 201 can receive at least part of light reflected by a fingerprint through the light transmitting area 3611 to recognize the fingerprint; and the light transmitting area 3611 is used as an optical channel for fingerprint recognition, which can reduce the occupation of a design space for the display panel 10 by a fingerprint recognition structure and achieve the full screen fingerprint recognition, thereby improving the speed and convenience of fingerprint recognition.

The terms such as “first” and “second” are only used for descriptive purposes, and cannot be construed as indicating or implying relative importance or implying the number of technical features indicated. Thus, the feature defined by “first”, “second”, etc. may explicitly or implicitly include one or more features. In the description of the present application, “a plurality of” means two or more, unless otherwise expressly and specifically defined.

In the present invention, the terms such as “assembly” and “connection” should be understood in a broad sense, unless otherwise expressly specified and defined. For example, “connection” may be fixed connection, detachable connection, or integrated connection; “connection” may be mechanical connection or electrical connection; and “connection” may be direct connection, indirect connection via an intermediate medium, internal connection between two elements, or interaction between two elements. Those of ordinary skill in the art may understand specific meanings of the above terms in the present application according to specific circumstances.

In the description of this specification, the description with reference to the terms such as “some embodiments” and “examples” means that the specific features, structures, materials or characteristics described in combination with the embodiments or examples are included in at least one embodiment or example of the present application. In this specification, the schematic representations of the above terms do not necessarily refer to the same embodiments or examples. Moreover, the specific features, structures, materials or characteristics described may be combined in a suitable manner in any one or more embodiments or examples. In addition, those skilled in the art may combine different embodiments or examples described in this specification and features of different embodiments or examples, without mutual contradiction.

Although the embodiments of the present application have been shown and described above, it may be understood that the above embodiments are exemplary and cannot be understood as a limitation to the present application. Those of ordinary skill in the art may make changes, modifications, substitutions, and variations to the above embodiments within the scope of the present application. Therefore, any changes or modifications made in accordance with the claims and specification of the present application should fall within the scope of the patent application.

What is claimed is:

1. A display panel, comprising:
a substrate;
a driving circuit layer formed on a side of the substrate, wherein the driving circuit layer comprises photosensitive devices;
a light emitting layer formed on a side of the driving circuit layer away from the substrate, wherein the light emitting layer comprises a plurality of anti-peeping sub-pixels and a plurality of display sub-pixels; and
a light shielding layer comprising a plurality of light shielding components, wherein each of the plurality of light shielding components comprises a light transmitting area and a light shielding area located on at least one side of the light transmitting area, wherein a corresponding one of the photosensitive devices is capable of receiving at least part of light reflected by a fingerprint through the light transmitting area, and wherein an orthographic projection of each of the plurality of anti-peeping sub-pixels on the light shielding layer is at least partially located in a corresponding one of the plurality of light shielding components.

2. The display panel according to claim 1, wherein an orthographic projection of a corresponding one of the photosensitive devices on the light shielding layer at least partially overlaps with the light transmitting area.

3. The display panel according to claim 2, wherein each of the plurality of light shielding components comprises two light shielding areas located on two sides of the light transmitting area in a row direction, respectively.

4. The display panel according to claim 3, wherein each of the plurality of light shielding components comprises four light shielding areas, wherein two of the four light shielding areas are located on the two sides of the light transmitting area in the row direction, respectively, and another two of the four light shielding areas are located on two sides of the light transmitting area in a column direction, respectively.

5. The display panel according to claim 4, wherein each of the plurality of anti-peeping sub-pixels comprises a first hollow area and edge areas, wherein the edge areas are arranged around the first hollow area, an orthographic projection of the first hollow area on the light shielding layer is located in the light transmitting area, and wherein an orthographic projection of each of the edge areas on the light shielding layer is located in a corresponding one of the four light shielding areas.

6. The display panel according to claim 1, further comprising a piezoelectric film, wherein the piezoelectric film comprises a plurality of piezoelectric components, a projection of the light transmitting area on the piezoelectric film is located in or coincides with a corresponding one of the plurality of piezoelectric components, wherein the piezoelectric film has a transparent state and an opaque state, the piezoelectric film is in the transparent state when being pressed, and the piezoelectric film is in the opaque state when being in a natural state.

7. The display panel according to claim 6, wherein each of the plurality of piezoelectric components is located in the light transmitting area.

8. The display panel according to claim 6, wherein each of the plurality of piezoelectric components is located on a side of a corresponding one of the plurality of light shielding components.

9. The display panel according to claim 6, wherein the light shielding layer is the piezoelectric film.

10. The display panel according to claim 1, further comprising a first anode layer, a pixel definition layer and a cathode layer, wherein the driving circuit layer, the first anode layer, the pixel definition layer, the light emitting layer, the cathode layer, and the light shielding layer are sequentially formed;
wherein the first anode layer comprises a plurality of first anodes and a plurality of second anodes, wherein the pixel definition layer comprises first via holes and second via holes, the plurality of display sub-pixels are at least partially located in the first via holes and are connected to the plurality of first anodes in a one-to-one correspondence manner, and wherein the plurality of anti-peeping sub-pixels are at least partially located in the second via holes and are connected to the plurality of second anodes in a one-to-one correspondence manner; and
wherein each of the plurality of second anodes at least comprises a reflective layer, wherein at least the reflective layer comprises a second hollow area, and wherein an orthographic projection of a corresponding one of the photosensitive devices on the first anode layer is located in the second hollow area.

11. The display panel according to claim 10, further comprising an encapsulating layer and a color resistor layer, wherein the encapsulating layer is formed on a side of the cathode layer away from the substrate, wherein the light shielding layer is formed on a side of the encapsulating layer away from the substrate, and wherein the color resistor layer is formed on a side of the encapsulating layer away from the substrate;
wherein the color resistor layer comprises a plurality of color resistors, and orthographic projections of the plurality of display sub-pixels on the color resistor layer are located in the plurality of color resistors in a one-to-one correspondence manner.

12. The display panel according to claim 1, further comprising a first anode layer, a pixel definition layer, a second anode layer and a cathode layer, wherein the driving circuit layer, the first anode layer, the pixel definition layer, the second anode layer, the light emitting layer, the cathode layer, and the light shielding layer are sequentially formed;
wherein the first anode layer comprises a plurality of first anodes, wherein the second anode layer comprises a plurality of second anodes, wherein the pixel definition layer comprises first via holes, the plurality of display sub-pixels are at least partially located in the first via holes and are connected to the plurality of first anodes in a one-to-one correspondence manner, wherein each of the plurality of anti-peeping sub-pixels is located between adjacent two of the first via holes, and each of the plurality of second anodes is located between adjacent two of the first via holes; and
wherein each of the plurality of second anodes at least comprises a reflective layer, wherein at least the reflective layer comprises a second hollow area, and wherein an orthographic projection of a corresponding one of the photosensitive devices on the first anode layer is located in the second hollow area.

13. The display panel according to claim 12, further comprising an encapsulating layer and a color resistor layer, wherein the encapsulating layer is formed on a side of the cathode layer away from the substrate, wherein the light shielding layer is formed on a side of the encapsulating layer away from the substrate, and wherein the color resistor layer is formed on a side of the encapsulating layer away from the substrate;
wherein the color resistor layer comprises a plurality of color resistors, and orthographic projections of the plurality of display sub-pixels on the color resistor layer are located in the plurality of color resistors in a one-to-one correspondence manner.

14. The display panel according to claim 10, wherein the plurality of display sub-pixels comprises a red display sub-pixel, green display sub-pixels and a blue display sub-pixel, wherein the plurality of display sub-pixels are distributed in a plurality of first pixel rows and a plurality of second pixel rows, and the plurality of first pixel rows and the plurality of second pixel rows are arranged alternately in a column direction;
wherein the red display sub-pixel and the blue display sub-pixel are arranged at intervals and alternately in the plurality of first pixel rows, while the red display sub-pixel and the blue display sub-pixel are arranged at intervals and alternately in the column direction;
wherein the green display sub-pixels are arranged at intervals in the plurality of second pixel rows, and the green display sub-pixels are staggered from both the red display sub-pixel and the blue display sub-pixel in the column direction;
wherein each anti-peeping sub-pixel is arranged between two adjacent green display sub-pixels and between the red display sub-pixel and the blue display sub-pixel that are adjacent to each other.

15. A display device, comprising a display panel and a mainboard, wherein the mainboard is connected to the display panel, wherein the display panel comprises:
a substrate;
a driving circuit layer formed on a side of the substrate, wherein the driving circuit layer comprises photosensitive devices;
a light emitting layer formed on a side of the driving circuit layer away from the substrate, wherein the light emitting layer comprises a plurality of anti-peeping sub-pixels and a plurality of display sub-pixels; and
a light shielding layer comprising a plurality of light shielding components, wherein each of the plurality of light shielding components comprises a light transmitting area and a light shielding area located on at least one side of the light transmitting area, wherein a corresponding one of the photosensitive devices is capable of receiving at least part of light reflected by a fingerprint through the light transmitting area, and wherein an orthographic projection of each of the plurality of anti-peeping sub-pixels on the light shielding layer is at least partially located in a corresponding one of the plurality of light shielding components.

16. The display device according to claim 15, wherein an orthographic projection of a corresponding one of the photosensitive devices on the light shielding layer at least partially overlaps with the light transmitting area.

17. The display device according to claim 16, wherein each of the plurality of light shielding components comprises two light shielding areas located on two sides of the light transmitting area in a row direction, respectively.

18. The display device according to claim 17, wherein each of the plurality of light shielding components comprises four light shielding areas, wherein two of the four light shielding areas are located on the two sides of the light transmitting area in the row direction, respectively, and another two of the four light shielding areas are located on two sides of the light transmitting area in a column direction, respectively.

19. The display device according to claim 18, wherein each of the plurality of anti-peeping sub-pixels comprises a first hollow area and edge areas, wherein the edge areas are arranged around the first hollow area, an orthographic projection of the first hollow area on the light shielding layer is located in the light transmitting area, and wherein an orthographic projection of each of the edge areas on the light shielding layer is located in a corresponding one of the four light shielding areas.

20. The display device according to claim 15, further comprising a piezoelectric film, wherein the piezoelectric film comprises a plurality of piezoelectric components, a projection of the light transmitting area on the piezoelectric film is located in or coincides with a corresponding one of the plurality of piezoelectric components, wherein the piezoelectric film has a transparent state and an opaque state, the piezoelectric film is in the transparent state when being pressed, and the piezoelectric film is in the opaque state when being in a natural state.
